(19) United States
(12) Patent Application Publication
(10) Pub. No.: US 2004/0174554 A1
(43) Pub. Date: Sep. 9, 2004

(54) Method and apparatus for compressing image data

(75) Inventors: Seung-don Lee, Gyeonggi-do (KR); Bong-gi Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/787,154

(22) Filed: Feb. 27, 2004

(30) Foreign Application Priority Data
Mar. 6, 2003 (KR) 2003-14002

(51) Int. Cl. G06K 15/02; H04N 1/393

(52) U.S. Cl. 358/1.13; 358/1.2

(57) ABSTRACT

A method and apparatus for compressing image data. The method of compressing image data comprises detecting a specified compression ratio corresponding to a printing mode selected by a user from compression ratios corresponding to a variety of printing modes, and compressing the image data according to the detected specified compression ratio.

### CROSS REFERENCE TO RELATED APPLICATION

This application claims the priority of Korean Patent Application No. 2003-14002, filed on Mar. 6, 2003, in the Korean Intellectual Property Office, the disclosure of which is incorporated herein in its entirety by reference.

### BACKGROUND OF THE INVENTION

1. Field of the Invention

The present invention relates to compressing image data and transmitting the image data to a printer so as to print the image data, and more particularly, to a method and apparatus for compressing image data in which a user selects a compression ratio of image data to be printed.

2. Description of the Related Art

In a conventional method of printing an image using a printer, by connecting a computer to a printer, image data in a computer is converted into a command and data that can be read by the printer, is output to the printer via a parallel port or a USB port, and an image is printed using the printer. More specifically, a user selects a printing mode, such as image quality and types of media, and gives a printing command via a user interface in a printer driver. The printer driver determines a rendering resolution, a half-toning method, a color matching method, and a command for a printing mode according to a printing mode selected by the user and performs data processing in order. The printer driver then compresses image data generated after halftone processing using a lossless compression method, such as a tagged image file format (TIFF). Thereafter, the compressed image data is added to the command prescribed in the printer and transmitted to the printer via the parallel or USB port. Interpretation of the command added to the transmitted image data is performed, and the image data is decoded, formatted in a data format that can be output to a printhead, and finally printed.

As the use of digital cameras increases, so to does the demand for outputting an image stored in a digital camera directly to a printer without the need for a computer. To meet this demand, new methods for outputting an image from a digital camera directly to a printer have been developed. Since the storage size of digital images is large, the digital images are compressed and then stored. A Joint photographic coding experts group (JPEG) compression method is widely used in photographic images, and most digital cameras store an image using the JPEG compression method. A JPEG compression technique is a standard for a technique for compressing an image so as to communicate information of a still image, such as a photo and follows data loss. In other words, a JPEG compression method is a method for removing data in a frequency region that a user cannot see. Since loss of an image is small and compression efficiency is very high, the JPEG compression method is widely used to compress digital photos. In addition, another advantage of the JPEG compression method is that a user can control an image quality and adjust the size of a file. In order to receive an image from a digital camera and print it, a printer for a digital camera decodes a JPEG image, performs data processing, such as color matching, half-toning, and formatting, and performs a printing operation.

A method of printing an image using a JPEG compression method is as follows. When the user selects a printing mode via a user interface in a driver and gives a printing command, the driver determines a rendering resolution according to the selected printing mode and performs rendering. After rendering is performed, a bitmap image is JPEG-compressed, and the JPEG-compressed image is transmitted to the printer via a parallel port or a USB port. The transmitted data is JPEG-decoded in the printer, color-matched, half-toned, and formatted, and finally printed.

As described above, image compression methods include a lossless compression method and a data loss compression method. A JPEG compression method follows data loss and is suitable to compress a photographic image. However, in the JPEG compression method, the higher a compression ratio of image data, the smaller the size of the image data, but the larger loss of an image. Conversely, the lower a compression ratio of image data, the smaller loss of an image, but the larger the size of the image data such that a time required to transmit data to the printer is increased and burdens on hardware units for processing data transmission increase. In this way, there is a trade-off between a compression ratio and an image quality. In addition, the compression ratio has a close relation with transmission speed and printing speed of image data.

However, the user cannot determine the compression ratio of the image data with respect to the image quality or printing speed when printing the image data. Accordingly, the user prints an image having a high resolution for a long time even though the user does not need the image having the high resolution. When the image having the high resolution needs to be obtained even though a long time is required, the user prints an image having a low resolution within a short time.

### BRIEF SUMMARY

The present invention provides a method of compressing image data, by which a user selects a compression ratio of image data according to the quality of an image, and the like, such that the quality and printing speed of an image to be printed are optimized.

The present invention also provides an apparatus for compressing image data, by which a user selects a compression ratio of image data according to the quality of an image, and the like, such that the quality and printing speed of an image to be printed are optimized.

According to an aspect of the present invention, there is provided a method for compressing image data, the method comprising detecting a specified compression ratio corresponding to a printing mode selected by a user from compression ratios corresponding to a variety of printing modes, and compressing the image data according to the detected specified compression ratio.

According to another aspect of the present invention, there is provided an apparatus for compressing image data, the apparatus comprising a compression ratio detection unit which detects a specified compression ratio corresponding to a printing mode selected by a user from compression ratios corresponding to a variety of printing modes and outputs the detected specified compression ratio, and a data compression unit which compresses the image data according to the detected specified compression ratio.

According to still another aspect of the present invention, there is provided an image data compressing system including: a compression ratio detection section which detects a specified compression ratio corresponding to a printing mode selected by a user from compression ratios corresponding to a variety of printing modes and outputs the detected specified compression ratio; and a data compression section which compresses the image data according to the detected specified compression ratio.

According to yet another aspect of the present invention, there is provided a computer readable storage medium encoded with processing instructions for causing a computer to perform a method of compressing image data. The method includes: detecting a specified compression ratio corresponding to a printing mode selected by a user from compression ratios corresponding to a variety of printing modes; and compressing the image data according to the detected specified compression ratio.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a flowchart illustrating a method of compressing image data according to an embodiment of the present invention;

FIG. 2 illustrates an example of a lookup table for explaining a method of compressing image data according to the method shown in FIG. 1;

FIG. 3 illustrates an example of a dialogue window for selection of a printing mode, for explaining the method shown in FIG. 1; and

FIG. 4 is a block diagram illustrating a structure of an apparatus for compressing image data according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, a method for compressing image data according to embodiments of the present invention will be described in detail with reference to the attached drawings.

FIG. 1 is a flowchart illustrating a method of compressing image data according to an embodiment of the present invention. The method for compressing image data according to the embodiment of the present invention includes compressing image data according to a specified compression ratio corresponding to a printing mode selected by a user (processes 10 and 20). This method is executable by computer and is storable on a computer readable storage medium.

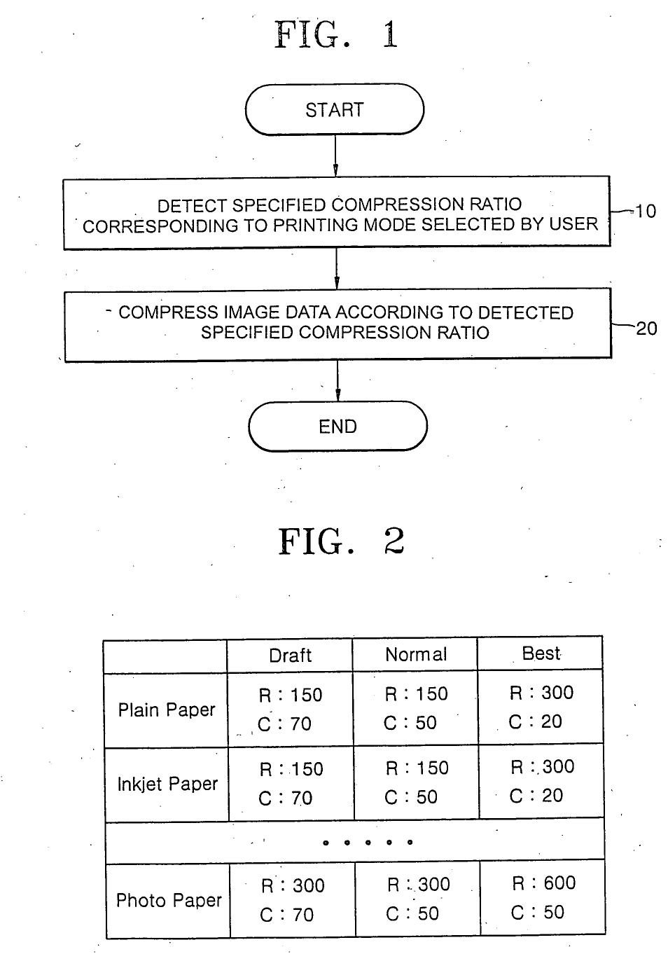

FIG. 2 illustrates an example of a lookup table for explaining the method shown in FIG. 1. ‘R’ shown in FIG. 2 denotes a rendering resolution in units of dot per inch (dpi). In addition, ‘C’ shown in FIG. 2 denotes a compression ratio of image data in units of %.

First, in process 10, a predetermined compression ratio corresponding to a printing mode selected by a user from compression ratios corresponding to a variety of printing modes is detected. The variety of printing modes provide varying settings to account for various factors, including, for example, the degree of an image quality, the type of a printing paper, a printing color or the type of image data. The degree of an image quality may include draft, normal, and best, as shown in FIG. 2. Draft quality is obtained by a printing mode in which an image quality is relatively low, that is, a compression ratio is high. Normal quality is obtained by a printing mode in which an image quality is higher than an image quality of draft and lower than that of best and a compression ratio is between a compression ratio of draft and that of the best. Best quality is obtained by a printing mode in which an image quality is the highest and a compression ratio is lower than that of draft or normal. The type of a printing paper may include, for example, a plain paper, inkjet paper, and a photo paper, as shown in FIG. 2. The printing color may include color or gray. A compression ratio of image data is determined according to a printing color selected by the user and printed. The type of image data includes, for example, a text, a graphic, a text and graphic, a document or a photo, and the like.

The compression ratios corresponding to a variety of printing modes are previously stored on a recording medium. As shown in FIG. 2, compression ratios corresponding to printing modes are provided in advance in the form of a lookup table. Since resolution as well as a compression ratio of image data is a base of determining the degree of an image quality, the resolution of an image is provided as information of the lookup table together with the compression ratio.

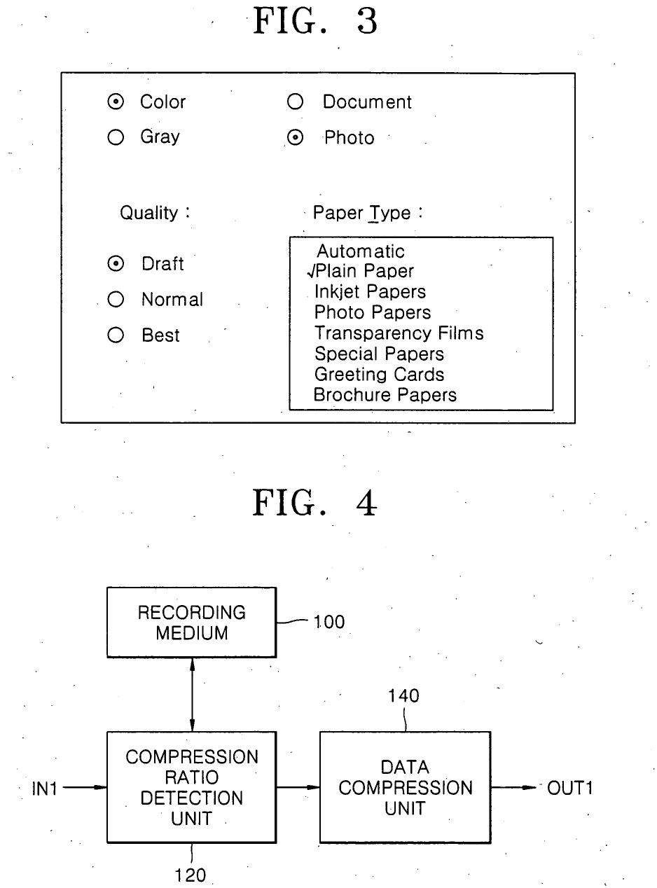

FIG. 3 illustrates an example of a dialogue window for selection of a printing mode in the method shown in FIG. 1. When the user selects a printing mode using the dialogue window, a specified compression ratio corresponding to the selected printing mode is detected. For example, when the user wants to print a color photo having the lowest image quality on a plain paper, the user selects a printing mode for each of a color paper, a photo paper, a draft paper, and a plain paper from a variety of printing modes on the dialogue window shown in FIG. 3. When the user selects a printing mode using the dialogue window, the resolution and compression ratio of “R: 150 dpi, C: 70%” corresponding to a printing mode selected by the user are detected from the lookup table shown in FIG. 2.

After process 10, in process 20, image data is compressed according to the detected specified compression ratio. In this case, the image data is compressed by a data loss compression method. For example, the image data is compressed by a joint photographic coding experts group (JPEG) compression method. As described above, in the JPEG compression method, data in a frequency region that the user cannot see is removed. Thus, the user can control an image quality and adjust the size of a file.

For example, when each of the resolution and compression ratio of “R: 150 dpi, C: 70%” corresponding to a printing mode selected by the user is determined in process 10, the image data is compressed according to the determined specified compression ratio.

The compressed image data is transmitted to a printer at a transmission speed corresponding to the compressed size and printed as an image quality corresponding to the aforementioned resolution.

Hereinafter, an apparatus for compressing image data according to an embodiment of the present invention will be described.

FIG. 4 is a block diagram illustrating a structure of an apparatus for compressing image data according to an embodiment of the present invention. The apparatus for compressing image data according to this embodiment includes a recording medium 100, a compression ratio detection unit 120, and a data compression unit 140.

The recording medium 100 stores compression ratios corresponding to a variety of printing modes. The variety of printing modes provide varying settings to account for various factors, including, for example, the degree of an image quality, the type of a printing paper, the type of image data or a printing color. The recording medium 100 stores compression ratios corresponding to the variety of printing modes, such as the degree of an image quality, the type of a printing paper, the type of image data or a printing color, in the form of a lookup table. FIG. 2 illustrates an example of a lookup table. The degree of an image quality, the type of a printing paper or a printing color is as described above, and thus, descriptions thereof will be omitted. The compression ratios corresponding to the variety of printing modes may be stored on the recording medium 100, but compression ratios may be provided according to a variety of printing modes using equations.

The compression ratio detection unit 120 detects a specified compression ratio corresponding to a printing mode selected by the user from the compression ratios corresponding to the variety of printing modes and outputs the detected specified compression ratio.

For example, the compression ratio detection unit 120 requests the recording medium 100 of the specified compression ratio corresponding to the printing mode selected by the user and detects the requested specified compression ratio as a specified compression ratio for compression of image data.

The compression ratio detection unit 120 includes a user interface (not shown) for selection of a printer mode. FIG. 3 illustrates a dialogue window displayed by the user interface. As shown in FIG. 3, the compression ratio detection unit 120 displays the dialogue window in which the degree of an image quality, the type of a printing paper, the type of image data or a printing color is used as a printing mode. When the dialogue window for the printing mode is displayed, the user selects a printing mode required for printing of an image. For example, when the user wants to print a color photo having the lowest image quality on a plain paper, the user selects a printing mode for each of a color paper, a photo paper, a draft paper, and a plain paper from a variety of printing modes on the dialogue window shown in FIG. 3. The compression ratio detection unit 120 inputs a printing mode for each of the color paper, the photo paper, the draft paper, and the plain paper through an input terminal IN1 and requests the recording medium 100 of the specified compression ratio corresponding to the selected printing mode for each of the color paper, the photo paper, the draft paper, and the plain paper. The compression ratio detection unit 120 detects the specified compression ratio corresponding to the printing mode for each of the color paper, the photo paper, the draft paper, and the plain paper from the recording medium 100 and outputs the detected predetermined compression ratio to the data compression unit 140.

The data compression unit 140 compresses the image data according to the input specified compression ratio. The data compression unit 140 performs compression on the image data by a data loss compression method. For example, the data compression unit 140 performs compression on the image data according to the specified compression ratio input by the compression ratio detection unit 120 and outputs the compressed image data to an output terminal OUT1.

The image data compressed by the data compression unit 140 is transmitted to a printer (not shown) through a parallel or USB port, and the transmitted image data is decoded, color-matched, half-toned, and formatted in the printer and finally printed.

As described above, in the method of and apparatus for compressing image data according to the described embodiments of the present invention, when the image data is compressed and transmitted to the printer so as to print an image, the user can select a compression ratio of the image data according to the quality of the image, such that the quality and printing speed of an image to be printed are optimized.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

What is claimed is:

1. A method of compressing image data comprising:
detecting a specified compression ratio corresponding to a printing mode selected by a user from compression ratios corresponding to a variety of printing modes; and
compressing the image data according to the detected specified compression ratio.

2. The method of claim 1, wherein the compression ratios corresponding to the variety of printing modes are stored on a recording medium.

3. The method of claim 2, wherein the compression ratios corresponding to the variety of printing modes are stored in a lookup table on the recording medium.

4. The method of claim 3, wherein the variety of printing modes provide varying settings to account for factors including at least one of a degree of an image quality, a type of a printing paper, a type of image data, and a printing color.

5. The method of claim 4, wherein the degree of image quality includes at least a draft quality, a normal quality, and a best quality.

6. The method of claim 5, wherein the draft quality yields a low first image quality and a high first image compression ratio.

7. The method of claim 6, wherein the normal quality yields a second image quality higher than the first and a second compression ratio lower than the first.

8. The method of claim 7, wherein the best quality yields a third image quality higher than the second image quality and a third compression ratio lower than the second compression ratio.

9. The method of claim 1, wherein the printing is selected by a user via a user interface.

10. The method of claim 4, wherein the variety of paper includes at least automatic, plain paper, inkjet paper, photo paper, transparency films, special paper, greeting paper, and brochure paper.

11. The method of claim 3, wherein image resolution is stored in the look up table.

12. The method of claim 1, wherein the compressing is performed on the image data by a data loss compression method.

13. The method of claim 12, wherein the compressing is preformed on the image data by a JPEG compression method.

14. The method of claim 1, wherein the method is performed for a print operation to print the image data.

15. An apparatus for compressing image data comprising:
a compression ratio detection unit which detects a specified compression ratio corresponding to a printing mode selected by a user from compression ratios corresponding to a variety of printing modes and outputs the detected specified compression ratio; and
a data compression unit which compresses the image data according to the detected specified compression ratio.

16. The apparatus of claim 15, wherein the compression ratios corresponding to the variety of printing modes are stored on a recording medium.

17. The apparatus of claim 16, wherein the compression ratios corresponding to the variety of printing modes are stored in a lookup table on the recording medium.

18. The apparatus of claim 17, wherein the variety of printing modes varying settings to account for factors including at least one of a degree of an image quality, a type of a printing paper, a type of image and a printing color.

19. The apparatus of claim 18, wherein the variety of image quality includes at least a draft quality, a normal quality, and a best quality.

20. The apparatus of claim 19, wherein the draft quality yields a low first image quality and a high first image compression ratio.

21. The apparatus of claim 20, wherein the normal quality yields a second image quality higher than the first and a second compression ratio lower than the first.

22. The apparatus of claim 21, wherein the best quality yields a a third image quality higher than the second image quality and a third compression ratio lower than the second compression ratio.

23. The apparatus of claim 1, wherein the printing is selected by a user via a user interface.

24. The apparatus of claim 18, wherein the variety of paper includes at least automatic, plain paper, inkjet paper, photo paper, transparency films, special paper, greeting paper, and brochure paper.

25. The apparatus of claim 17, wherein image resolution is stored in the look up table.

26. The apparatus of claim 15, wherein the data compression unit performs compression on the image data by a data loss compression method.

27. The apparatus of claim 26, wherein the data compression unit performs compression on the image data by a JPEG compression method.

28. An image data compressing system comprising:
a compression ratio detection section which detects a specified compression ratio corresponding to a printing mode selected by a user from compression ratios corresponding to a variety of printing modes and outputs the detected specified compression ratio; and
a data compression section which compresses the image data according to the detected specified compression ratio.

29. The system of claim 28, further comprising a storage section which stores the compression ratios corresponding to the variety of printing modes.

30. The method of claim 29, wherein the compression ratios corresponding to the variety of printing modes are stored in a lookup table in the storage section.

31. A computer readable storage medium encoded with processing instructions for causing a computer to perform a method of compressing image data comprising:
detecting a specified compression ratio corresponding to a printing mode selected by a user from compression ratios corresponding to a variety of printing modes; and
compressing the image data according to the detected specified compression ratio.
